(19) United States
(12) Patent Application Publication
(10) Pub. No.: US 2024/0317624 A1
(43) Pub. Date: Sep. 26, 2024

(54) METHOD FOR DRYING PREFERABLY BIOGENIC RESIDUES, AND BIOREACTOR FOR CARRYING OUT THE METHOD

(71) Applicant: MUTEC MARKGRAF GMBH, Bahrdorf (DE)

(72) Inventors: Udo COMES, Braunschweig (DE); Karl MARKGRAF, Bahrdorf (DE)

(73) Assignee: MUTEC MARKGRAF GMBH, Bahrdorf (DE)

(21) Appl. No.: 18/574,508

(22) PCT Filed: Jul. 1, 2022
(86) PCT No.: PCT/EP2022/068321

§ 371 Date: Dec. 27, 2023

(30) Foreign Application Priority Data
Jul. 2, 2021 (DE) 10 2021 116 025.1
Aug. 30, 2021 (DE) 10 2021 122 391.1
Sep. 7, 2021 (DE) 10 2021 123 157.4

(51) Int. Cl. C02F 11/13; B01F 27/92; B01F 35/90; B01F 35/91; B01F 101/00; F26B 3/04; F26B 11/14

(52) U.S. Cl. CPC C02F 11/13; B01F 27/92; B01F 35/91; F26B 3/04; F26B 11/14; B01F 2035/99; B01F 2101/005; B01F 2101/305; C02F 2303/26; F26B 2200/02; F26B 2200/12; F26B 2200/16; F26B 2200/18

(57) ABSTRACT

The invention relates to a method and a bioreactor for drying biogenic residues to a dry mass comprising filling the residues into a bioreactor filled with spheres and mixing the spheres and the residues so that films of the residues form on the surfaces of the spheres, drying the films of residues with the formation of crusts of dry mass with a residual water content on the surfaces of the spheres by feeding a drying medium into the bioreactor,

grinding and further drying the dry mass by mixing and grinding off powdery dry mass from the spheres.

The invention relates to a method for drying preferably biogenic residues by supplying a drying medium. The invention also relates to a bioreactor for carrying out the method.

### BACKGROUND OF THE INVENTION

Biogenic residues offer several potentials, in particular nutrients, energy, phosphorus and metals, which are often insufficiently utilised by the current process chains. Biogenic residues are often only disposed of and not utilised.

The nutrients contained in biogenic residues are often in a chemically unstable and aqueous form and are not suitable for transport over long distances. Examples include liquid manure and fermentation residues.

The energy potential of biogenic residues is the energy chemically bound in the complex organic molecules, which can be used as biomass fuel for the direct replacement of fossil fuels.

Another potential resource is phosphorus, an essential raw material that is neither replaceable nor renewable. For this reason, various methods are currently being developed to recover phosphorus from biogenic residues having a phosphorus content.

Metals can be contained in different concentrations and combinations in solids. Some metals are rare elements that are only found in low concentrations in the earth's crust. These include cobalt, for example, which is required in battery production for electromobility, meaning that the raw material is currently in high demand.

Lastly, the water bound in the form of moisture in the residues is a valuable commodity as drinking water or process water.

Based on this, the object of the invention is to describe a method by which, in particular, biogenic residues are processed in order to be able to utilise the potentials present in the residues, in particular nutrients, energy, phosphorus, metals and water, as valuable substances. A further object of the invention is to create a bioreactor with which the method can be carried out.

### DESCRIPTION OF THE INVENTION

To solve the problem, the method is characterised by the following steps:
a) filling biogenic residues with a liquid content into a bioreactor,
b) drying the residues to a dry mass,
c) grinding the dry mass,
d) removing the dry mass.

During the grinding in step c), the dry mass can be dried further.

According to a more specific description, the method comprises the following steps:
a) filling the residues having a liquid content into a bioreactor filled with (preferably dry) spheres and having a mixer, and mixing the spheres and the residues by operating the mixer at least intermittently during the filling and/or after the filling, so that films of the residues form on the surfaces of the spheres,
b) drying the films of residues with the formation of crusts of dry mass with a residual water content on the surfaces of the spheres by feeding a drying medium into the bioreactor, which flows around the spheres, with at least temporary operation of the mixer,
c) grinding and further drying the dry mass by operating the mixer at least intermittently while grinding off powdery dry mass from the spheres,
d) discharging the powdery dry mass from the bioreactor.

The result of the method is a very dry and very finely divided powdery dry mass (hereinafter also referred to simply as powder), which can be used in a variety of ways depending on the starting material (the residue).

In particular, the powder can be used as a substitute fuel for fossil fuels, especially wherever a combustion process is currently carried out using fossil fuels, particularly coal. One example is the cement industry when burning clinker. In this way, fossil CO₂ emissions can be effectively reduced.

Furthermore, the dry mass can be used as a nutrient-rich fertiliser in agriculture in the form of dry meal, in particular by mixing chemically unstable liquid manure or fermentation residues with particularly dry biogenic residues, thereby utilising the nutrients in the residue.

Furthermore, a concentrated discharge of nitrogen via the gas phase is possible, which enables the isolated recovery of nitrogen via an acid scrubber.

The method also allows phosphorus contained in the residue to be recovered and used in particular likewise as fertiliser.

In addition to this, metals can be extracted from the residues so that they can be used as raw materials in the production processes of goods.

Lastly, the water discharged from the reactor with the drying medium as a result of the method can be subsequently utilised by treating it as service water or drinking water. By drying seawater, two valuable substances are thus produced simultaneously: salt as a dry mass and water via the separation of the water from the drying medium with subsequent treatment to give drinking water or process water.

The method according to the invention can thus utilise all of the potentials described in the introduction.

The term ‘residue’ is understood broadly in the context of the invention and includes in particular, but not exclusively, biogenic residues. Biogenic residues are organic waste and waste water, agricultural and forestry by-products and biogenic production residues. In addition, the term residue for the description of the starting materials of this method includes all heterogeneous material mixtures with organic components. These include sewage sludge (primary sludge, secondary sludge, tertiary sludge, digested sludge) as well as liquid manure, fermentation residues, pond or river sludge, seawater and algae and other residues from marine plants and animals, as well as other organic material mixtures, secondary raw materials and industrial sludge.

During the grinding in step c), the dry mass can be dried further.

According to an alternative embodiment, the method comprises two stages, wherein the first stage is also referred to as the “wet” stage and the second stage is referred to as the “dry” stage. During the “wet” stage, the films of residues are substantially dried with the formation of crusts on the surfaces of the spheres while the mixer is operated at least temporarily, which also causes the powder to be separated from the spheres. During the “dry” stage, the grinding and further drying of the powdery dry mass, which has already been separated from the spheres, takes place by operating the mixer due to the grinding action of the spheres and the discharge of the powdery dry mass from the bioreactor. The “dry” stage, which includes further drying and grinding, can thus be carried out as an independent process and can be performed in addition to the first stage.

In a preferred embodiment of the invention, the drying medium is a drying fluid, in particular a gaseous fluid. In the context of the invention, warm, unsaturated air and/or unsaturated, superheated water vapour are preferably used as gaseous drying fluids. The application of the principle of steam drying using superheated water vapour also leads to a considerable increase in the efficiency of the heat transfer and thus to a time saving compared to the use of warm, unsaturated air as the drying medium. The principle of steam drying using superheated water vapour at atmospheric pressure is known per se.

The drying process is accompanied by the vaporisation of liquid, in particular water (moisture). The vaporisation of liquids is defined as a phase change from the liquid to the gaseous phase and thus the conversion of the liquid into vapour. In thermodynamic terms, vapour is a real gas that can be discharged from the reactor chamber, which in the present case is done by the drying medium. The term vaporisation is a generic term that generally describes the phase transition from the liquid to the gas phase and thus includes evaporation below the boiling point and boiling above the boiling point of a liquid.

Water vapour can be a component of a gas mixture. Water vapour in the atmosphere, for example, is a component of the gas mixture humid air. Humid air is a mixture of dry air and water. In contrast to other mixtures of ideal gases, humid air has the special feature that water vapour cannot be mixed with dry air in any quantity. The air can only contain such a quantity of water vapour until the partial pressure of the water vapour (partial pressure) has reached the saturation pressure. If the partial pressure of the water vapour is less than the saturation pressure, the air is unsaturated.

Vapour with a higher temperature than the saturation temperature is unsaturated, superheated vapour. Thus, on the one hand, water vapour in unsaturated humid air below the boiling temperature is superheated vapour. On the other hand, a vapour can occur completely isolated and fill a room on its own, especially if the vapour is kept above the boiling temperature.

In order for a liquid to turn into vapour, heat of vaporisation (thermal energy) must be added to it, because vaporisation is associated with a considerable increase in volume, among other things. For example, the increase in volume during the vaporisation of water at a pressure of 1 bar is more than 1600 times higher. If we consider isobaric vaporisation, the heat of vaporisation is an enthalpy of vaporisation. The energy input required for the transition of 1 kg of water to water vapour at atmospheric pressure (1013.25 hPa) and 100° C. is 2257 kJ.

The energy input can take place by convection (in the present case according to the invention with the aid of the drying medium) and/or conduction (via hot contact surfaces, e.g. heated outer walls of the bioreactor according to the invention) and/or by radiant heat (e.g. through transparent outer walls of a bioreactor according to the invention described later).

In addition, the biogenic residues fed in can preferably be heated before feeding (up to boiling temperature at most).

The intensity and combination of the various heat transfer processes depend on the material properties of the biogenic residue to be dried and the desired drying result, which also includes disinfection/hygienisation. Heat transfer by convection using the drying medium is the preferred method.

In addition to this, other process parameters, in particular the temperature and pressure (negative pressure/vacuum, positive pressure) can be varied to optimise process control and product quality, as these parameters directly influence the drying process. The boiling temperature, for example, is a dependent function of the set pressure level. Preferably, temperatures above 0° C. up to 250° C. and positive (positive pressure) or negative (negative pressure) pressure differences of 0-4 bar are set with reference to the atmospheric pressure.

The spheres can be made of any material as long as it has sufficient water absorption capacity in the form of hygroscopicity and/or capillarity and strength. The spheres are preferably made of wood and in particular beech wood. Alternatively, the spheres can be made of another material that has similar properties to wood, in particular with regard to moisture regulation and strength. For example, wood-plastic composites are possible.

The diameter of the spheres is preferably between 5 mm and 50 mm, in particular preferably between 15 mm and 30 mm.

In order to achieve additional removal of moisture from the residue film (hereinafter also referred to as biofilm) settling on the surfaces by sorption and additional capillary forces in the spheres, these can be dried before the residues are filled or fed in. This can be done in particular by feeding the drying medium, especially warm unsaturated air and/or unsaturated, superheated water vapour, into the reactor.

A mixing process can be carried out during the filling of the residues. Preferably, at least one mixing process is carried out after filling. This ensures that the residues are completely mixed with the spheres at least once.

The mixing process or mixing processes continue until uniform thin films of the residues have formed on the surfaces of the spheres.

In order to fix comparatively dry residues to the surfaces of the spheres and to form the films on the surfaces of the spheres, additional liquid can be applied to the surfaces of the spheres when the residues are filled in. In this way, the dry residues are slurried or sludged on and adhere stably to the surfaces of the spheres. The liquid can be introduced in particular by spraying the liquid in the form of a spray mist. The liquid can be water or another (biogenic) residue with a higher moisture content. In this way, simultaneously supplied drier and wetter residues can be fixed to the surfaces of the spheres as thin biofilms.

According to one embodiment, liquid manure or fermentation residues are used as further (biogenic) residues with higher moisture contents. By selectively mixing chemically unstable liquid manure or fermentation residues with very dry, preferably biogenic residues, a nutrient-rich fertiliser mixture can be produced as a dry meal and thus as a dry stabiliser using the method presented here.

Additional liquid is preferably introduced when the moisture content of the residue used falls below a lower threshold.

The added liquid can be enriched with an iron salt to precipitate free phosphates in the residue as iron phosphate.

The liquid can also contain lime (calcium carbonate CaCO₃), which can be added in the form of milk of lime, for example, and distributed evenly over the sphere surfaces.

Alternatively, lime can also be fed into the bioreactor as a solid, in particular in the form of a free-flowing powder. The addition of lime increases the pH value of the biofilms forming on the spherical surfaces, which enables a targeted reduction in the temperature level required for the phase transition of nitrogen, which is usually available in the form of ammonium in the biogenic residues, from the liquid to the gaseous phase.

This allows the gaseous discharge of ammonia (NH₃) to be specifically influenced with the help of the drying medium. The nitrogen discharged in gaseous form as a result can then be fed into further processing and thus separated as a nutrient. This can preferably be done by an acid scrubber using sulphuric acid (H₂SO₄) so that ammonium sulphate solution can be produced.

In the case of drying using warm, unsaturated air as the drying medium, the warm, unsaturated air is preferably introduced into the bioreactor at a temperature of up to 85° C. The spheres are then surrounded by the introduced air, wherein the films adhering to the sphere surfaces release moisture into the air. The saturated air is discharged again from the bioreactor. Optionally, the water contained in the saturated air can be channelled for further use.

For drying using unsaturated, superheated water vapour as the drying medium, the unsaturated, superheated water vapour is introduced into the bioreactor at a temperature of 110° C. to 300° C. in particular, preferably 110° C. to 250° C. The set process parameters can be varied in terms of pressure and temperature, taking into account the limit values for the gas phase, which are derived from the vapour pressure curve. Preferably, the water vapour is introduced into the bioreactor at atmospheric pressure. The superheated water vapour then flows around the spheres. The residues absorb the heat convectively. The films adhering to the spherical surfaces, which have a liquid content, evaporate moisture, which the hot vapour absorbs as a real gas. The moisture discharged from the biogenic residues thus becomes excess vapour, which is discharged again from the bioreactor. Optionally, the water contained in the discharged excess vapour can be put to further use.

Drying causes crusts to form on the surfaces of the spheres, said crusts consisting of dry mass with a residual water content. During the mixing processes, the crusts are finely ground (rubbed off) from the surfaces of the spheres and are deposited as powder (powdery dry mass) with a residual water content at the base of the bioreactor.

Preferably, during drying, the drying medium is supplied via several drying medium inlets arranged at different heights in the bioreactor, in particular a drying medium inlet arranged in the lower third of the bioreactor, a drying medium inlet arranged in the centre filling level area, a drying medium inlet arranged above a maximum filling level, and a drying medium inlet arranged in the base area. The drying medium supply in the lower area of the bioreactor, in particular from the drying medium inlet arranged in the lower third of the bioreactor and the drying medium inlet arranged in the base area, can be reduced or switched off when crust formation begins on the surfaces of the spheres. This ensures that the drying medium no longer flows through the powdery dry mass that accumulates in the base area. This prevents the highly flammable powder from being whirled up and discharged with the exhaust air or excess vapour. This measure therefore serves not only to retain the powder in the reactor, but also as explosion protection.

The powder at the base of the bioreactor is preferably dried indirectly, wherein there is no direct flow of the drying medium (“aeration”). Indirect drying can take place via the surfaces of the spheres, in particular by sorption and additional capillary suction forces, which are located in the powder mixture in the base area of the bioreactor and are preferably drier than the powder surrounding them.

Without stirring up the powder in the base area of the bioreactor, the drying medium can flow around the spheres above the powder during grinding and can be dried in the process. In particular, the drying medium is supplied via the drying medium inlet located in the centre filling level area and the drying medium inlet located above the maximum filling level, while the drying medium is not supplied via the other drying medium inlets.

The sorptive removal of water molecules in combination with the grinding of the powder breaks up agglomerates and successively reduces the size of particles in the ground material.

The size reduction of the individual particles in the form of agglomerates is determined and limited, among other things, by the water molecules that act as liquid bridges between the particles. By removing the water molecules, the particles can be increasingly separated down to the single-digit μm range.

Indirect drying via the surfaces/interfaces of the spheres also makes it possible to dry powder cold by mixing fully dried spheres into a powder bed, wherein the temperatures of the spheres and the powder do not exhibit large temperature differences. As a drying result, indirect drying can achieve full drying of powder with a dry residue content of up to 98%. The spheres and the powder are preferably mixed at intervals. During the mixing process, the powder is ground by the friction at the surfaces of the spheres.

For thermal hygienisation of the (biogenic) residues, the residence time of the biogenic residues in the bioreactor can be set for a predetermined period of time, which is based on the respective legally valid specifications for hygienisation.

A bioreactor which is set up to carry out the method according to the invention has the following features:
a housing with at least one base and a preferably closed peripheral wall,
a mixer, which is preferably mounted on the base rotatably about a vertical axis and which is arranged inside the housing,
at least one drying medium inlet arranged in the centre area or in the centre of the peripheral wall of the housing in relation to a height of the housing or to a maximum fill level (Hₘₐₓ) of the housing,
at least one drying medium outlet,
a filling of the bioreactor from a plurality of spheres, with an initial fill level (Hₛₜₐᵣₜ)
at least one feed line for residues, and
at least one discharge device for removing the dried residues.

A further drying medium inlet can be arranged in the base or in the peripheral wall. A cumulative arrangement can also be provided in the base and in the peripheral wall.

A plurality of drying medium inlets can be provided in the peripheral wall and also in the base in order to ensure a sufficient supply of drying medium. In particular, the bioreactor can comprise a plurality of drying medium inlets, in particular a drying medium inlet arranged in the lower third of the bioreactor in the peripheral wall, the drying medium inlet arranged in the centre filling level area in the peripheral wall, a drying medium inlet arranged above the maximum filling level in the peripheral wall or a lid and/or a drying medium inlet arranged in the base.

The drying medium can be supplied and distributed at specific points and/or via distributor plates, each of which has a plurality of holes and extends over at least part of the reactor cross-section. This allows drying medium to be fed and distributed over defined areas.

Preferably, the housing can be covered by a lid. In this case, the residues are preferably fed in and the drying medium is removed through the lid, in which corresponding openings are provided. Alternatively, the drying medium can be discharged and the residues fed in through the side peripheral wall above the maximum fill level by providing corresponding openings.

Irrespective of the design of the bioreactor, with or without a lid, the residues can alternatively be fed into the side peripheral wall below the surface of the maximum filling level, preferably using a screw. In itself, it is irrelevant from where or at which point the biogenic residues are fed into the bioreactor.

The mixer is preferably a vertical screw. The vertical screw can preferably be conical or cylindrical. Preferably, at least one blade and a scraper bar at the start of the screw can also be attached to the screw turns or screw flights (segmented screw). The mixer is preferably mounted on the base of the housing.

The housing is preferably cylindrical or conical.

Preferably, the housing is thermally insulated in order to keep the temperature in the bioreactor constant during the drying process.

The exhaust air or excess vapour can be discharged from a closed bioreactor by internal pressure or by applying a vacuum. The applied temperatures can be varied by varying the pressures applied. In the case of negative pressure, the temperature can be lowered, and in the case of positive pressure, the temperature can be increased. The construction of the bioreactor must be designed with a lid according to the selected pressure conditions.

The individual method steps are explained in greater detail below.

### (a) Filling of Residues Having a Liquid Content

The aim of the first method step is to evenly distribute the supplied (biogenic) residues on the surfaces of the spheres in the form of thin films with a layer thickness of preferably a few millimetres.

For this purpose, the residues are preferably fed into the bioreactor above the sphere bed.

The spheres are preferably made of wood, in particular beech wood. Alternatively, other moisture-regulating materials with sufficiently strong surfaces can also be used. The diameter of the spheres can preferably be between 5 and 50 mm. For example, around 73,000 spheres with an average diameter of 25 mm are used per cubic metre of used volume of the bioreactor. The sum of the sphere surfaces per cubic metre is therefore 144 m² (square metres).

From a geometric point of view, spherical bodies are preferably used to carry out the method. Alternatively, preferably round or oval-shaped bodies can also be used.

The residues are preferably added while the mixer is in operation, at least intermittently, in order to mix the spheres and residues. The mixing process should preferably last several minutes so that a uniform film can form on all the spheres. The mixing process is preferably carried out in the bioreactor by a vertical screw.

The residues fed in can have different material properties and particle sizes. For example, a fed mixture can simultaneously consist of liquid, wet, moist, sticky, solid, crumbly and powdered fractions. The size of the solid particles fed in can also vary from 1 μm in a suspension to several centimetres as solid lumps.

If residues with dry fractions that have a water content of <70% are fed in, water is preferably added to the bioreactor in order to slurry or sludge on the dry fractions. This can preferably be done by way of a spray mist above the spheres and during the mixing process.

A further special feature of the supplied biogenic residues in particular can be the phosphorus they contain. In the event that phosphorus is to be separated in order to obtain a fuel that has been depleted of phosphorus, the availability in the form of iron phosphate or another paramagnetic metal phosphate in the residues is desirable, which enables magnetic separation of the material, in particular by means of a magnetically effective separator (absorber).

In the event that the phosphate contained in the (biogenic) residue is in the form of a non-magnetic metal salt or as dissolved phosphate, water enriched with a suitable iron salt can be added to the bioreactor. The feed preferably takes place in the form of a spray mist above the spheres during the mixing process while residues are being fed in. The added aqueous iron salt solution is evenly mixed into the films by the mixing process and then, in the presence of phosphate dissolved in the aqueous films, leads to a precipitation of phosphate as iron phosphate in a few minutes.

For the use of biogenic residues as fertiliser, the production of iron phosphates should be avoided, as this almost completely inhibits the absorption of phosphorus by the plants. For this reason, the iron phosphate can be magnetically separated from the powdery dry mass produced and fed to a subsequent processing operation.

A further differentiation with regard to the biogenic residues fed in is the degree of chemical instability of the organic content. This easily degradable proportion of organic matter, consisting of energy-rich complex organic fat and protein molecules, should preferably be quickly converted into a stable form in order to preserve the chemically bound energy and minimise odours.

One form of stabilisation is the conversion to a dry stabilised state. The lack of water prevents the transport of nutrients for the mostly heterotrophic bacteria, which begin to degrade the organic components very quickly, and thus effectively stops the biological degradation of the easily degradable organic substances.

The spheres are therefore preferably dried before filling. When the wet film is distributed on the surfaces of the spheres, water is drawn from the wetter film from the outside inwards into the drier cell cavities of the spheres as free water via the boundary surfaces of the spheres by capillary attraction forces. By drawing moisture inwards, the film is dried and stabilised by the resulting dry rigidity.

In principle, the hygroscopic property of the spheres enables the moisture to be adapted to the prevailing external conditions. The associated ability to store moisture enables the introduction into the bioreactor of very aqueous suspensions, the water content of which can be absorbed up to the saturation limit of the spheres.

As a result of this method step, all the spheres in the bioreactor are covered with a thin film.

### (b) Drying of the Residues to a Dry Mass

The biogenic residues, which are present in the form of wet films on the spheres, are dried by supplying a drying medium, preferably at a temperature above room temperature up to 85° C. when warm unsaturated air is used as the drying medium and preferably at a temperature above 110° C. when unsaturated, superheated water vapour is used as the drying medium. The drying medium is preferably supplied at several points arranged at different heights in the bioreactor. The drying medium is preferably supplied from the base of the reactor, from its peripheral wall, specifically in the region of the spheres at the level of the powder accumulation and in the region of the spheres above the powder accumulation, as well as above the sphere bed.

When warm unsaturated air is used as the drying medium, the aqueous surfaces of the films dry in this phase primarily by releasing water as water vapour into the unsaturated warm air flowing around them and thus discharging water as water vapour from the bioreactor via the more saturated exhaust air.

When using unsaturated, superheated water vapour as a drying medium, the aqueous surfaces of the films dry in this phase primarily by releasing water as water vapour in the form of a real gas into the unsaturated, superheated water vapour flowing around them and thus discharging water from the bioreactor as excess vapour.

The preferential mechanical mixing of the spheres leads to an increase in the wet surfaces, as the wet films transfer moisture to drier films and are formed back into homogeneous wet biofilms after mixing.

If no fresh residues are added, the wet films dry out and dry mass is produced in the form of dry crusts (dry mass with residual moisture) on the surfaces of the wood spheres.

The dry crusts should preferably increase the diameter of the spheres by 5% to 10%. This increases the utilised volume in the reactor by up to 33%. The filling density of the sphere matrix is around 60%, leaving a free volume (air volume when using warm, unsaturated air as the drying medium and vapour volume when using unsaturated, superheated water vapour as the drying medium) of around 40%.

When crust formation begins or when the moist films transition to superficially dry crusts, but at the latest after complete crust formation, the drying medium supply to the lower area of the reactor is reduced or interrupted so that the drying medium supply substantially only takes place in the region of the spheres above the powdery dry mass now accumulating in the lower reactor area.

### (c) Grinding and Drying the Dry Mass

The dry mass adhering to the surfaces of the wood spheres is rubbed off or ground down as free-flowing material by friction during mixing processes. Most of the free-flowing material settles at the base of the bioreactor.

As the availability of free free-flowing materials increases, the mixing processes lead to the free-flowing materials being ground into a microfine powder. As a result, the particle size is less than 100 μm and preferably less than 60 μm. Individual particles are ground down to the single-digit μm range.

With the transition from the wet phase to the dry powder phase, the dry mass is dried further. However, the type of drying changes. The powder is no longer dried directly via the drying medium, but indirectly via the capillary suction forces and sorption at the dry interfaces of the spheres. The water in the powder is therefore transported from the outside to the inside of the cell cavities of the spheres via the boundary surfaces of the spheres by sorption and capillary attraction forces and is bound there.

For this purpose, the part of the spheres not coated in powder and located above the powder layer deposited on the base continues to be dried by the drying medium, by the warm and unsaturated air flow when warm unsaturated air is used as the drying medium, and by the superheated and unsaturated vapour flow when unsaturated, superheated water vapour is used as the drying medium. A subsequent mixing process mixes very dry spheres from the upper area into the powder in the lower area of the bioreactor. In addition, the spheres that are in the powder and that have previously been enriched with water from the powder are mixed from the powder into the upper part of the bioreactor and thus above the powder layer into the spheres located there.

Further drying removes water from the powder, which then enables further grinding of the powder because the water acting as a binder is increasingly removed. The final dry residue content of the powder should preferably be between 90% and 98% by weight, i.e. should have a moisture content of at most 10% and up to 2% by weight.

The grinding process is preferably carried out until the spheres are substantially free of dry mass, i.e. the crusts have been removed as far as possible.

The drying medium supply is then completely interrupted and operation of the mixer is stopped. The drying medium discharge continues at a reduced level in order to maintain a continuous negative pressure.

### (d) Discharge of the Dry Mass

The powder can preferably be carried out of the reactor pneumatically with the drying medium, in particular by suction air or negative pressure with the aid of cyclones. Heavier impurities can be easily separated in the flow of the drying medium, especially in the air flow, by the air separation process.

Alternatively, the powder can be discharged via a discharge device comprising lateral openings or openings in the base area of the reactor. Preferably, a sieving device, in particular a perforated plate or a grid or rods, can be arranged in front of the openings in order to retain at least the spheres and optionally coarser components of the dry mass. A device for optionally opening and closing the discharge device can also be arranged in front of the sieving device on the inside of the housing.

The discharged dry mass can now be subjected to further quality assurance. This preferably includes the process for separating phosphorus, particularly in the form of iron phosphate. In addition, externally supplied dry mass can also be integrated into the phosphorus separation process.

Iron phosphate is paramagnetic and is particularly present in particle sizes of 5 μm to 50 μm. To enable separation from the hygroscopic bulk material in powder form, the dry mass must preferably be comminuted to a maximum size of 100 μm with a simultaneously high dry residue content of more than 90% up to 98%. These two parameters are essential in order to achieve free-flowing pourability and avoid clumping in the powder. When setting the parameters, there are smooth transitions and therefore gradual differences in the degree of separation depending on the magnetic field strength. In addition, clumping has a direct effect on the degree of purity of the separated iron phosphate particles, as foreign substances adhere with increasing clumping.

The grinding of the dry mass for the purpose of phosphate separation can take place in a mill, or generally in a comminution unit. The device should enable the particles to be reduced to a particle size <100 μm.

A purely mechanical comminution of the particles is limited by the residual moisture in the dry mass. If the residual moisture in the externally supplied or discharged dry mass is too high, comminution can therefore be inhibited down to the single-digit μm range. A further preferred alternative procedure is then to feed or return the externally supplied or discharged and preferably comminuted dry mass to the process phase (c) grinding and drying of the dry mass until the necessary dry residue content is reached, which enables comminution down to the preferably single-digit μm range.

Alternatively, the drying and grinding of externally supplied or discharged and preferably powdery dry mass can preferably be carried out or continued in a second, separate mixer as an independent process.

During the filling process of the dry mass, magnetic metal compounds, in particular iron phosphate, can be separated from the powdery dry mass in a drop section by a magnetic separator, in that the iron phosphate particles are attracted by the magnetic field and are deposited directly on the magnet or on a plate in front of it. As a result, the by-product iron phosphate is separated from the main product of the powdery dry mass.

Magnetic separation can take place in different ways. On the one hand, a baffle plate in the drop section can lead to atomisation of the dry mass, from which the fine iron phosphate particles are then separated magnetically. On the other hand, a tube magnet can be used for free-fall applications, as is also used in the pharmaceutical industry for separating weakly magnetised particles. Furthermore, a drum magnet, an overband magnet or other magnetic systems can be used for separation.

The magnet is advantageously an electromagnet, which in particular preferably magnetises the housing wall of a storage container. In such a design, it may be sufficient to fill the powder into the storage container from above in free fall so that it swirls on the baffle plate. The iron phosphate particles then settle on the housing wall.

With the aid of drawings, an exemplary embodiment of the invention for the extended method using biogenic residues with a liquid content as starting materials will be explained in greater detail below, in which:

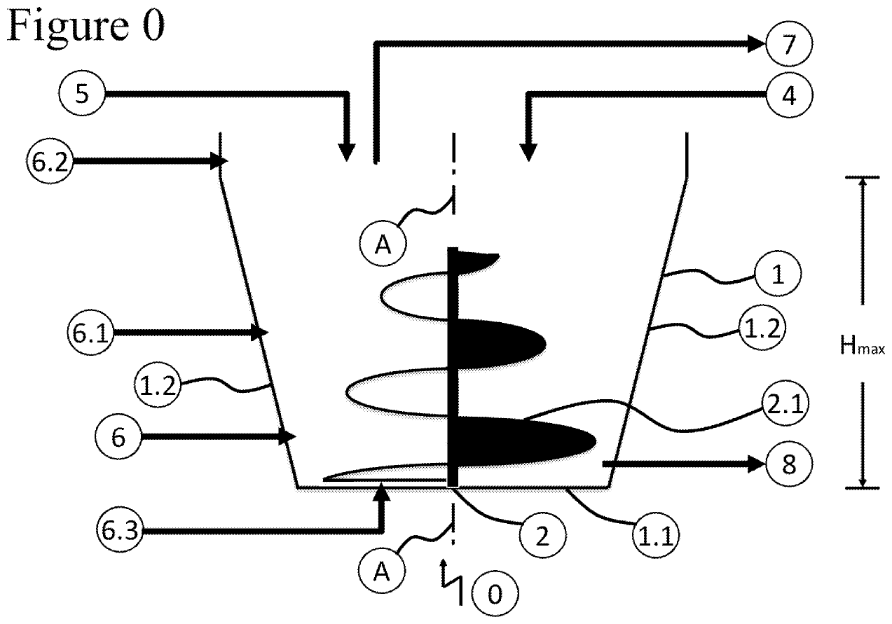

FIG. 0 shows a schematic representation of an unfilled bioreactor according to one embodiment of the invention;

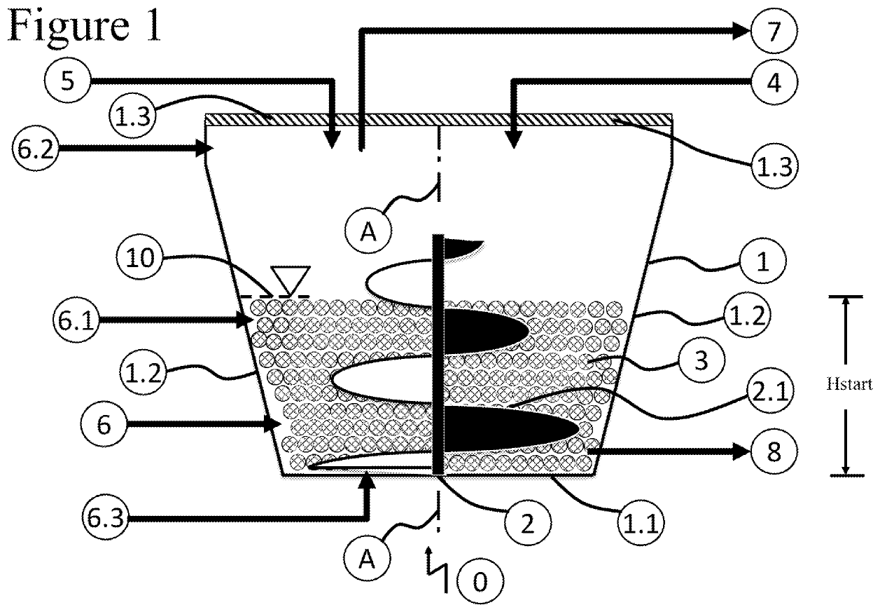

FIG. 1 shows a schematic representation of the bioreactor from FIG. 0 with spheres filled in, which are clean (unwetted) on the surface, with a filling height Hₛₜₐᵣₜ;

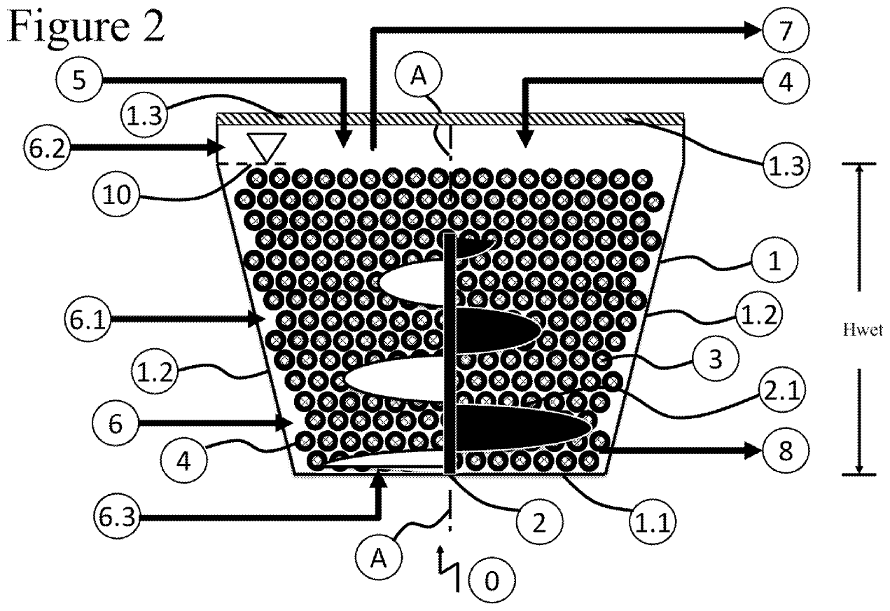

FIG. 2 shows a schematic representation of the bioreactor from FIG. 0 with spheres filled in, which have formed biofilms on the surface, with a maximum filling height H_{wet};

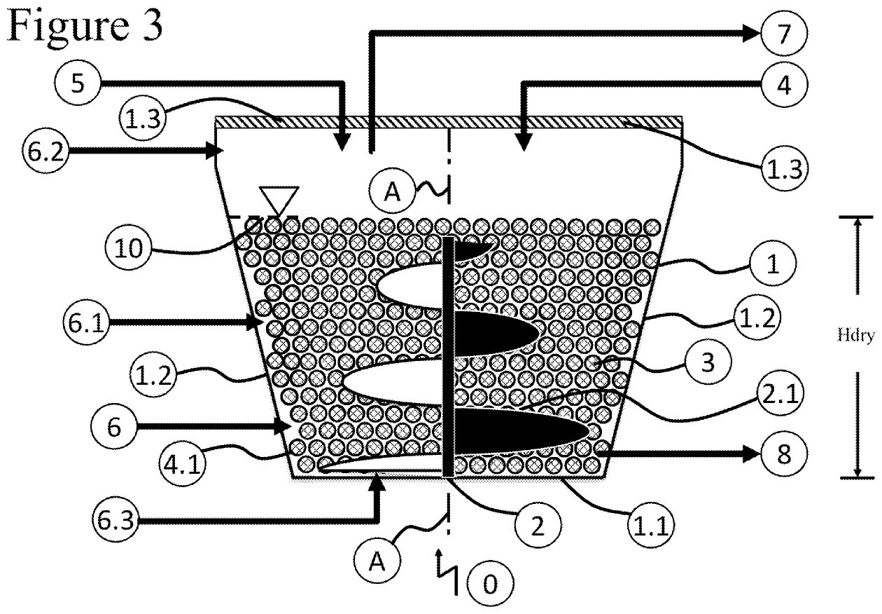

FIG. 3 shows a schematic representation of the bioreactor from FIG. 0 with spheres filled in, which have formed crusts on the surface, with an average filling height of H_{dry};

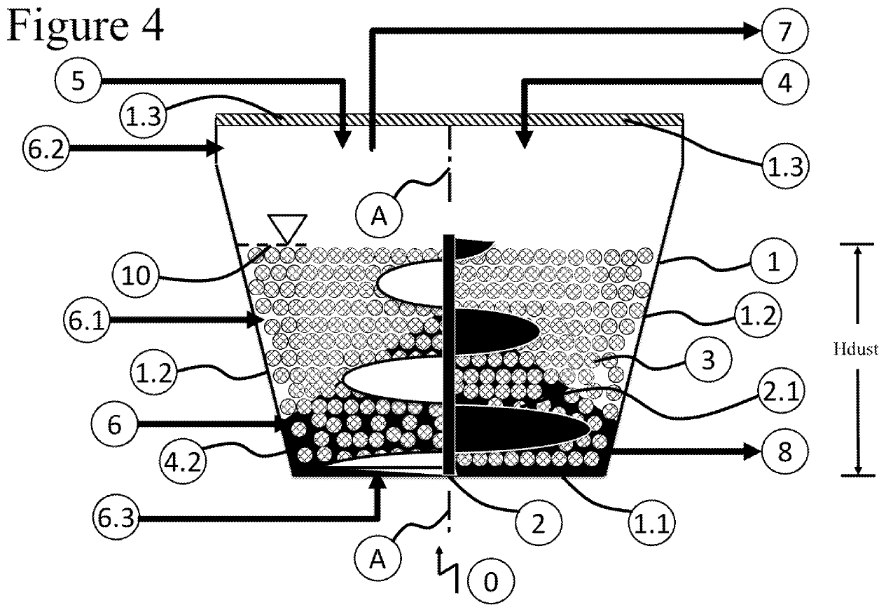

FIG. 4 shows the schematic representation of the bioreactor from FIG. 0 with spheres filled in, which are clean again on the surface, and with powder deposited at the base of the container, with a minimum filling level of H_{powder};

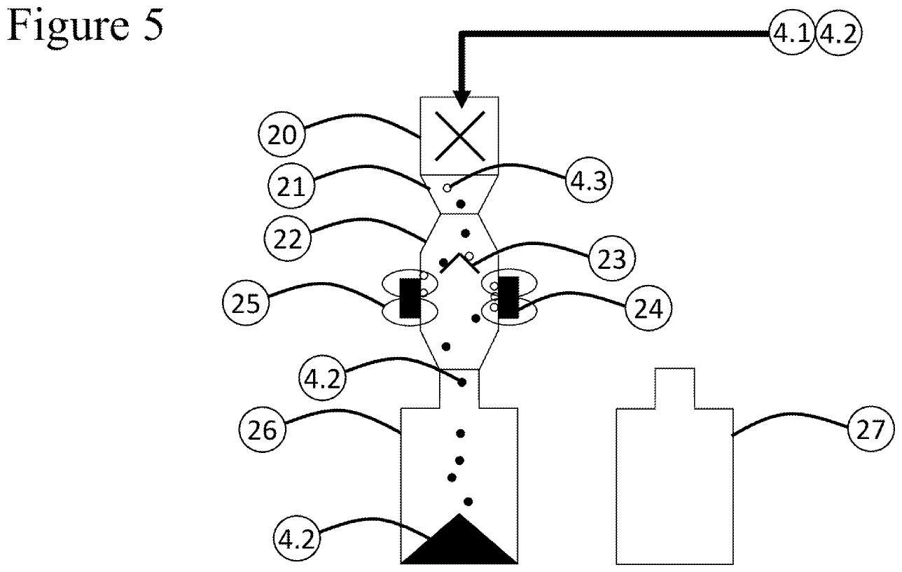

FIG. 5 shows a schematic representation of a system for separating a magnetic, phosphorus-containing compound, in particular iron phosphate, in a state with energised magnets; and

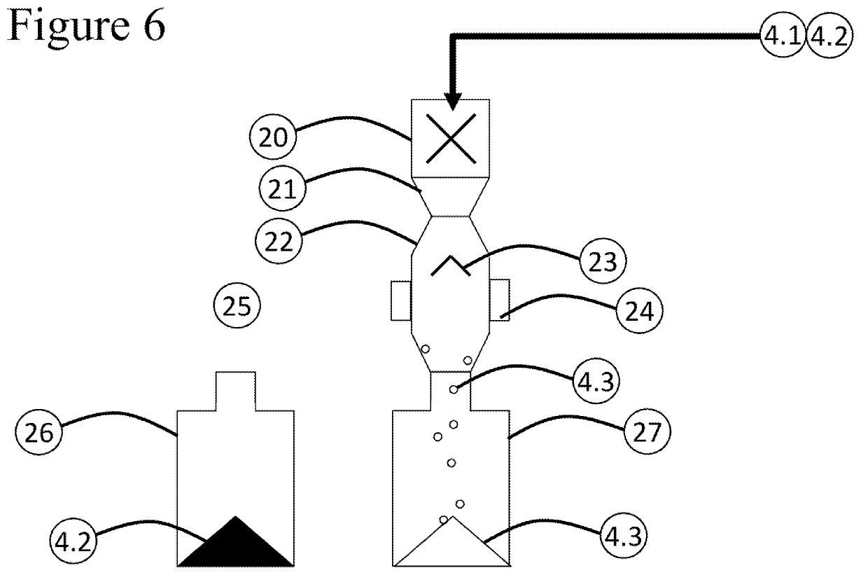

FIG. 6 shows a schematic representation of the system from FIG. 5 with deactivated magnets.

The bioreactor 0 is a thermal dryer, which in the exemplary embodiment shown in FIG. 0 consists of an upwardly open housing 1, which is conical in shape and substantially consists of a closed peripheral wall 1.2 and a base 1.1.

It is not shown in the schematic diagram that the housing 1 of the bioreactor 0 can be thermally insulated in order to keep the temperature inside the bioreactor 0 as constant as possible.

A preferably conical screw 2 is mounted in the base 1.1 so that it can be driven in rotation about the vertical axis A. The screw 2 has at least one turn 2.1. The screw 2 is shown shortened here. Preferably, its axial length extends up to the maximum filling height Hₘₐₓ in order to enable the fastest and quickest possible mixing.

Supply lines 6, 6.1, 6.2 and 6.3 are provided in the base 1.1 and in the peripheral wall 1.2 for the drying medium, which is preferably ambient air and/or unsaturated, superheated water vapour, which is fed into the interior of the bioreactor 0, which serves to dry the biogenic residues 4. In relation to the maximum filling height Hₘₐₓ of the housing 1, the feed line 6 is located in the lower third, the feed line 6.1 in the centre and a further feed line 6.2 above the spherical bed (see FIG. 1). The supply line 6.3 is located in the base 1.1. When using warm unsaturated air as the drying medium, the ambient air can preferably be heated to a temperature in the range of 20° Celsius to 85° Celsius. If unsaturated, superheated water vapour is used as the drying medium, the unsaturated, superheated vapour can preferably be heated to a temperature in the range of 110° Celsius to 250° Celsius.

Before the operation for drying biogenic residues can begin, a plurality of spheres, in this case wood spheres 3, which are preferably made of beech wood with a diameter of preferably 5-50 mm as bulk material, are filled into the bioreactor 0 via the upper opening shown in FIG. 0 up to a filling height of Hₛₜₐᵣₜ.

As soon as the wood spheres 3 have been filled into the bioreactor 0, the bioreactor 0 can be closed with a lid 1.3, as shown in FIG. 1.

The bioreactor 0 shown in FIG. 1 has the same structure as the bioreactor 0 shown in FIG. 0, but the housing 1 is now closed by a lid 1.3 and the bioreactor 0 is filled with wood spheres 3. The supply lines for biogenic residues 4 and water 5 and the discharge line for the outflowing drying medium 7 lead through the lid 1.3.

Before biogenic residues 4 are filled into the bioreactor 0, the wood spheres 3 are preferably dried in order to create a high potential in the wood spheres 3 for absorbing moisture.

The drying medium is preferably supplied via all feed lines 6, 6.1, 6.2 and 6.3 in order to introduce heat into the bioreactor 0 for drying. Preferably, the drying medium is warm, unsaturated air and/or unsaturated, superheated water vapour. The supply of warm air and/or vapour via the feed line 6.3 serves as a leakage medium (leakage air and/or leakage vapour) for discharging the saturated air and/or excess vapour from the lower part of the bioreactor 0, which has previously flowed through the spherical matrix. The exhaust air and/or vapour is discharged via the discharge line 7 in the lid 1.3. The air flows and/or vapour flows preferably create a slight negative pressure in the bioreactor 0. The aeration and ventilation and/or the vapour supply and removal preferably take place continuously. The specific design of the air supply and/or the vapour supply with regard to the duration, the volume flow and the temperature with reference to the individual air supply lines and/or vapour supply lines 6, 6.1, 6.2 and 6.3 is variable with the aim of obtaining optimum conditions for the drying process.

The vertically arranged screw 2 is then started up in rotation and the biogenic residues 4 are preferably fed in at the same time via the feed pipe in the lid 1.3. The mixing process mixes the biogenic residues 4 with the wood spheres 3 and preferably takes several minutes. The mixing process ends with largely homogeneously formed biofilms on the surfaces of the wood spheres 3.

In the event that the supplied biogenic residues 4 are too dry and the formation of biofilms is inhibited and therefore insufficient, water 5 is preferably fed into the bioreactor 0 via a feed line in the lid 1.3 during the mixing process. This causes the dry fractions of the biogenic residues 4 to be slurried and sludged on. The biogenic residues 4 enriched with water 5 then successively form biofilms on the surfaces of the wood spheres 3 during the mixing process.

If phosphorus in the form of dissolved phosphates or similar or in the form of non-magnetic compounds is still available in the biogenic residues that are to be separated after the drying process, a suitable magnetic reagent is added to convert the phosphorus into a magnetic compound. For example, an iron salt is added to the water 5 during the mixing process so that dissolved phosphates in the wet biofilms are spontaneously precipitated as iron phosphate.

The bioreactor 0 shown in FIG. 2 shows the state after the successful formation of biofilms on the surfaces of the wood spheres 3. The biofilms cause the level in the bioreactor 0 to rise to H_{wet}.

In the further process, the wet biofilm is dried. As described above, drying is carried out by supplying warm air and/or unsaturated, superheated water vapour into the spherical matrix via the surfaces of the biofilms, preferably continuously via all air supply lines and/or vapour supply lines 6, 6.1, 6.2 and 6.3. The air saturated with water vapour and/or the excess vapour is removed via the exhaust air line and/or the vapour outlet 7 in the lid 1.3.

The screw 2 is preferably operated at intervals. For this purpose, the screw 2 is preferably stopped for around 3-60 minutes, particularly preferably 30-60 minutes, and then preferably started up in rotation for 10-30 seconds at a time. The selected intervals are directly dependent on the thermal energy supplied to the bioreactor for drying. In the event that unsaturated, superheated water vapour is supplied as the drying medium, the mixer can preferably be operated quasi-continuously. The mechanical friction process homogenises the biofilms on the surfaces of the wood spheres 3 so that the moisture of the biofilms is largely evenly distributed over all the surfaces of the spheres, thus optimising the effective surface area for evaporation.

The aim of the drying process is to form solid, dry crusts 4.1 of solids on the surfaces of the wood spheres 3. The crusts should preferably increase the diameter of the wood spheres 3 by between 5% and 10%. This guide value makes it possible to calculate the preferably solid mass to be added and thus also the fresh mass of biogenic residues.

The biogenic residues are preferably fed in several partial portions. Each further partial portion of biogenic residues 4 is preferably fed after partial drying of the biofilms on the wood spheres 3, which have formed as a result of the feeding of biogenic residues 4.

When the feeding of biogenic residues 4 is complete, the biofilms are dried so that solid, dry crusts form on the surfaces of the wood spheres 3.

FIG. 3 shows the bioreactor 0, filled with wood spheres 3, on which solid, dry crusts 4.1 have formed. The fill level has dropped slightly and results in H_{dry}.

For the further drying process, the base aeration and/or the vapour supply line 6.3 and the lower lateral aeration and/or vapour supply line 6 are now switched off in order to avoid whirling up increasingly settled powder 4.2 in the base area of the bioreactor 0. The aeration and/or vapour supply is preferably continuous through the spherical matrix with supplied warm air and/or supplied unsaturated, superheated water vapour via the air line and/or vapour supply line 6.1. In addition, leakage air and/or leakage vapour is preferably supplied via the supply air line and/or vapour supply line 6.2 and the exhaust air and/or excess vapour is continuously discharged via the exhaust air line and/or vapour discharge line 7.

The screw 2 is also preferably operated at intervals. For this purpose, the screw 2 is preferably stopped for around 3-60 minutes, particularly preferably 30-60 minutes, and then preferably started up for 10-30 seconds at a time. The mechanical friction process successively removes the dry crusts 4.1 on the surfaces of the wood spheres 3 by friction. For the most part, the abrasion takes place directly in the form of coarse and fine powder particles 4.2, which are largely deposited in the base area of the bioreactor. The coarse and partially fine powder particles 4.2 already in the bioreactor are ground by friction between the surfaces of the wood spheres 3 into a fine powder with a particle size of less than 100 μm.

In addition to the grinding process, the separation process of the powder particles is supported by the drying of the powder. As the initially dry particles lose their low residual moisture and thus become dry as powder, a successive separation of particles that were previously adhesively bonded by water is made possible.

The powder drying process takes place indirectly via the surfaces of the wood spheres 3 by capillary suction forces, which equalise small differences in moisture between the powder particles and the surfaces of the wood spheres 3.

When wood spheres 3, which were previously dried in the upper area of the bioreactor 0, enter the powder 4.2 located in the base area 1.1 of the bioreactor 0 through the intermittent mixing process, indirect drying of the powder particles 4.2 takes place by sorption and capillary suction forces to equalise the moisture differences at the interfaces of the drier surfaces of the wood spheres 3 and the wetter surfaces of the powder particles 4.2. When wood spheres 3, which have previously absorbed moisture in the powder 4.2, enter the upper area of the bioreactor 0, the wood spheres 3 are dried directly by the warm air and/or the unsaturated, superheated water vapour.

Due to the intermittent mixing process, drier and wetter wood spheres 3 are exchanged at intervals between the upper area of the bioreactor 0 and the powder 4.2. This enables the powder 4.2 to be dried to a dry residue content of up to 98 wt. % and thus a water content of around 2 wt. %.

FIG. 4 shows the bioreactor 0 filled with wood spheres 3, the surfaces of which are free of solids, and powder 4.2 at the base 1.1 of the bioreactor. The filling level has dropped slightly to a level H_{powder}.

The powder 4.2 can now be removed via the discharge device 8. In principle, the powder 4.2 can be discharged in any desired manner.

In addition to the fine powder with a diameter <100 μm, a proportion of up to around 15% of the total weight of larger particles is often produced. This is dry mass in the form of spherical particles or other shapes, which are also discharged as free-flowing materials via the discharge unit 8. The size of the discharged solid particles depends on the selected discharge device and can range from 1 mm to several centimetres. Thus, the powder 4.2 of the dry mass 4.1 is often present as a heterogeneous mixture of particles with small diameters and coarser components with a diameter ≥100 μm.

Advantageously, the powdery dry mass 4.2 including the coarser components is therefore pneumatically discharged by suction air and/or negative pressure and then the coarser components are separated from the air flow and/or extracted gas flow (vapour flow) with the aid of cyclones. To separate the two fractions, a baffle plate can be used in the air flow and/or gas flow for air separation.

Preferably, a perforated plate is provided in front of the discharge opening, in the peripheral wall 1.2 of the bioreactor 0, to act as a sieve. This allows the maximum size of the particles discharged from the container to be determined, thus retaining the wood spheres 3. The perforated plate is preferably protected from the circulating spheres by a cover on the inside of the peripheral wall 1.2 of the bioreactor 0. If the holes are not covered, the holes become clogged with a liquid component by the biogenic residues supplied and then harden. Opening is then only possible mechanically with a drill or chisel. This procedure also applies analogously to other discharge devices, which must therefore preferably be protected from the interior of the bioreactor by a cover.

The reactor 0 described above can be part of the system according to the invention for separating the magnetic, phosphorus-containing compound 4.3 from the dry mass 4.1 and embodies the grinding device for grinding the dry mass 4.1 into a powder 4.2. The dry mass 4.1 thus obtained in the reactor 0 in the form of a powder 4.2 is then fed to a separation device for magnetic separation of the magnetic, phosphorus-containing compound. This separation device is described by way of example in the following FIGS. 5 and 6.

FIG. 5 shows such a separator for separating magnetic particles, in particular iron phosphate. The separator comprises an optional comminution unit 20, a hopper 21, a drop housing (drop tube) 22 with an angled baffle plate 23, and a magnet device 24 as well as a storage container 26, which can be arranged in a housing (not shown).

The dry mass 4.1 obtained from the reactor 0 is fed to the separator in the form of powder 4.2, which also contains the magnetic, phosphorus-containing compound 4.3. In particular, the powder 4.2 is fed into the optional comminution unit 20 for homogeneous mechanical grinding into powder 4.2. This is useful if the coarser dry mass particles with a diameter ≥100 μm were not previously separated from the powder 4.2 or if the dry mass 4.1 is obtained from a process other than the bioreactor 0, in which a sufficiently small particle size was not obtained. The comminution unit 20 may have a mechanical grinding mechanism, for example a cone grinding mechanism or a disc grinding mechanism or the like.

After grinding in the comminution unit 20, the entire mass, which is now largely homogeneous as fine powder 4.2, falls through the hopper 21 located below and then in free fall into the drop tube 22, where it hits the angled impact plate 23. The impact on the baffle plate 23 causes the powder 4.2 to swirl into a cloud of powder, which then continues to fall in free fall along the inner wall of the drop tube. The magnet device 24, preferably in the form of electromagnets, is arranged from the outside in the centre of the drop tube 22. When energised, the electromagnets generate a magnetic field 25 that acts in the inner area of the drop pipe. Due to the effective magnetic field 25, magnetic metal compounds of the phosphorus 4.3, for example iron phosphate, are magnetically attracted to the drop pipe wall from the inside and thus removed from the non-magnetic remaining powder 4.2. The powder 4.2 freed from magnetic metal compounds 4.3 continues to fall freely into the storage container 26 located below the drop pipe 22 and settles there in the base area.

An alternative process control can consist of treating the substances discharged from the bioreactor 0 separately. The coarse dry mass particles with a diameter ≥100 μm can be ground with the comminution unit 20 and then magnetically separated from the iron phosphate in the magnetic separator. The fine portion of powder 4.2 with a diameter <100 μm can be fed directly to the magnetic separator and magnetically separated from the iron phosphate.

It is understood that if the particle size of the dry mass is sufficiently small, an (additional) comminution process or the comminution unit 20 can be dispensed with.

FIG. 6 shows the separator as previously described in FIG. 5, but the storage container 26 has been placed to one side and the storage container 27 is now located under the drop pipe 22 to receive the separated magnetic, phosphorus-containing compound (for example iron phosphate particles) 4.3. Furthermore, the electromagnet 24 generating the magnetic field 25 has been switched off, so that the magnetic metal compounds 4.3 fall freely into the storage container 27 and settle there in the base area. The magnetic, phosphorus-containing compound (e.g. iron phosphate particles) 4.3 and the remaining dry mass 4.1 are thus received and collected separately from each other in the storage containers 27 and 26, respectively.

### LIST OF REFERENCE SIGNS

0 bioreactor
1 housing
1.1 base
1.2 peripheral wall
1.3 lid
2 mixer/screw
2.1 flight
3 wood sphere
4 biogenic residue
4.1 dry mass
4.2 powdery dry mass/powder
4.3 iron phosphate particle
5 water inlet/supply line/feed line
6 drying medium inlet/air inlet and/or vapour inlet/supply line/feed line
6.1 drying medium inlet/air inlet and/or vapour inlet/supply line/feed line
6.2 drying medium inlet/air inlet and/or vapour inlet/supply line/feed line 6.2
6.3 drying medium inlet/air inlet and/or vapour inlet/supply line/feed line
7 drying medium outlet/discharge line/exhaust air and/or vapour discharge
8 discharge device
10 surface
20 housing with comminution unit
21 conical funnel
22 drop pipe with conical end pieces
23 angled baffle plate for nebulisation
24 magnet device/electromagnet
25 magnetic field
26 storage container
27 storage container
30.1 housing wall
A axis
Hₘₐₓ filling height
Hₛₜₐᵣₜ filling height
H_{wet} filling height
H_{dry} filling height
H_{powder} filling height

1. A method for drying biogenic residues to a dry mass, comprising the following steps:
a) filling the residues (4) having a liquid content into a bioreactor (0) filled with spheres (3) and having a mixer (2), and mixing the spheres (3) and the residues (4) by operating the mixer (2) at least intermittently during the filling and/or after the filling, so that films of the residues (4) form on the surfaces of the spheres (3),
b) drying the films of residues (4) with the formation of crusts of dry mass (4.1) with a residual water content on the surfaces of the spheres (3) by feeding a drying medium into the bioreactor (0), which flows around the spheres (3), with at least temporary operation of the mixer (2),
c) grinding and further drying the dry mass (4.1) by operating the mixer (2) at least intermittently while grinding off powdery dry mass (4.2) from the spheres (3),
d) discharging the powdery dry mass (4.2) from the bioreactor (0).

2. The method according to claim 1, wherein the drying medium is a drying fluid which is in warm, unsaturated air and/or unsaturated, superheated water vapour.

3. The method according to claim 1, wherein the spheres (3) have a water absorption capacity, and are made of wood.

4. The method according to claim 1, wherein the spheres (3) are dried before the residues (4) are fed in, by feeding the drying medium into the bioreactor (0).

5. The method according to claim 1, wherein a liquid (5), being one of water and a further residue with a higher moisture content, is supplied onto the surfaces of the spheres (3) when the residues (4) are filled in.

6. The method according to claim 5, wherein the liquid (5) supplied contains an iron salt and/or lime.

7. The method according to claim 1, wherein, during the filling of the residues (4) and/or during the drying and/or during the grinding, the mixing process takes place intermittently.

8. The method according to claim 1, wherein, during the supply of the drying medium, moisture is discharged as water vapour with the drying medium, in particular as more highly saturated air and/or as excess vapour.

9. The method according to claim 1, wherein, during the grinding, the crusts of dry mass (4.1) are ground off from the surfaces of the spheres (3) and settle as powdery dry mass (4.2) with a residual water content at the base (1.1) of the bioreactor (0).

10. The method according to claim 1, wherein, during the grinding, the powdery dry mass (4.2) is dried at the base (1.1) of the bioreactor (0) via the surfaces of the spheres (3) which are located in the powdery dry mass (4.2) in the base area of the bioreactor (0), and there is no direct flow of the drying medium through the powdery dry mass (4.2).

11. The method according to claim 1, wherein, during the drying, the drying medium is supplied via a plurality of drying medium inlets (6, 6.1, 6.2, 6.3) arranged at different heights of the bioreactor (0), a drying medium inlet (6) arranged in the lower third of the bioreactor (0), a drying medium inlet (6.1) arranged in the centre filling level area, a drying medium inlet (6.2) arranged above a maximum filling level (Hₘₐₓ) and a drying medium inlet (6.3) arranged in the base area.

12. The method according to claim 11, wherein the drying medium supply in the lower region of the bioreactor (0), from the drying medium inlet (6) arranged in the lower third of the bioreactor (0) and the drying medium inlet (6.3) arranged in the base area, is reduced or switched off when crust formation begins on the surfaces of the spheres (3).

13. A bioreactor (0) designed to carry out a method according to claim 1, comprising:
a housing (1), with at least one base (1.1) and a peripheral wall (1.2),
a mixer (2), which is rotatably mounted about the vertical axis (A) and which is arranged inside the housing (1),
at least one drying medium inlet (6.1) arranged in the centre area of the peripheral wall (1.2) of the housing (1) in relation to a height of the housing (1) or to a maximum fill level (Hₘₐₓ),
at least one drying medium outlet (7),
a filling of the bioreactor (0) from a plurality of spheres (3), with an initial fill level (Hₛₜₐᵣₜ),
at least one feed line for residues (4), and
at least one discharge device (8) for removing dried residues.

14. The bioreactor (0) according to claim 13, further comprising a lid (1.3) which closes an upper opening of the bioreactor (0).

15. The bioreactor (0) according to claim 13, further comprising a plurality of drying medium inlets (6, 6.1, 6.2, 6.3), a drying medium inlet (6) arranged in the lower third of the bioreactor (0) in the peripheral wall (1.2), the drying medium inlet (6.1) arranged in the centre filling level area in the peripheral wall (1.2), a drying medium inlet (6.2) arranged above the maximum fill level (Hₘₐₓ) in the peripheral wall (1.2) or in the lid (1.3) and/or a drying medium inlet (6.3) arranged in the base (1.1).

16. The bioreactor according to claim 13, wherein a feed line (5) for liquids, is arranged above the maximum filling level (Hₘₐₓ).

17. The bioreactor (0) according to claim 13, wherein a sieving device being, a perforated plate or a grid or rods, is arranged in the housing (1) upstream of the discharge device (8).

18. The bioreactor (0) according to claim 17, wherein a device for selectively opening and closing the discharge device (8) is arranged in front of the sieving device towards the inside of the housing (1).
